(19) United States
(12) Patent Application Publication
(10) Pub. No.: US 2026/0267637 A1
(43) Pub. Date: Sep. 10, 2026

(54) MACHINE LEARNING BASED APPLICATION DEVELOPMENT TRACKING AND AGGREGATION

(71) Applicant: ADP, Inc., Roseland, NJ (US)

(72) Inventor: Emerson Roberto de Amaral Hinterholz, Porto Alegre (BR)

(73) Assignee: ADP, Inc., Roseland, NJ (US)

(21) Appl. No.: 19/558,191

(22) Filed: Mar. 5, 2026

Related U.S. Application Data
(60) Provisional application No. 63/767,928, filed on Mar. 6, 2025.

(51) Int. Cl. G06F 8/71; G06N 20/00

(52) U.S. Cl. CPC G06F 8/71; G06N 20/00

(57) ABSTRACT

A computing architecture for machine learning based application development tracking and aggregation is provided. A system can receive, using an application programming interface call, a data stream from a digital channel. The system can detect, based on the data streams and machine learning, an indication of a modification to a process executed by an application. The system can trigger, responsive to the detection of the indication, a validation operation for the modification to the process, and compare a version of the application corresponding to the modification with a previous version of the application stored prior to the indication of the modification. The system can validate, based on the comparison, the indication of the modification to the process and execute an action, responsive to the validation.

### CROSS-REFERENCES TO RELATED APPLICATIONS

This application claim benefit and priority under 35 U.S.C. § 119 to U.S. Provisional Patent Application No. 63/767,928, filed Mar. 6, 2025, which is hereby incorporated by reference herein in its entirety.

### FIELD OF THE TECHNOLOGY

This patent application generally relates to computing technology, particularly application development tracking, and more particularly to machine learning based application development tracking and process aggregation.

### BACKGROUND

Designers can develop applications using different types of design tools, which can provide various types of data. Over time, aspects associated with the design of an application can vary, and features of the application can be updated using the different types of design tools and types of data. It can be technically challenging to reliably track and aggregate design updates across the different tools and types of data, which can result in an erroneous or inefficient application or incompatibilities among different components of the application.

### SUMMARY

Technical solutions described herein are directed to providing a computing architecture for machine learning-based tracking and aggregation of application process development. When a large team of designers works on the development of an application or its processes, changes can be made to various parts of the project. Tracking such changes is often time-consuming and challenging, as well as unreliable and prone to errors. For example, as different features of an application are modified by one team member, other team members may be unaware of the modification in real-time. As a result, even diligent manual documenting of the application development progress can fall short of timely informing the team members of the modifications made. This increases the risk of misunderstandings and errors resulting in the waste of compute and energy resources, data mishandling, miscommunications, or erroneous design interactions, leading to computational and energy consumption inefficiencies.

The technical solutions overcome these challenges by providing a machine learning-based computing architecture for tracking and aggregation of application process development. The system of the technical solutions can receive data streams from digital channels and use machine learning models to detect modifications to processes. The system can trigger validation operation for detected modifications, comparing the modified application version with a previous version and validating the modification based on this comparison. Upon validation, the system can execute an action related to the modification, such as to document the modification in the form of a report, a message or an updated timeline of the project, maintaining an aggregated knowledge base of the project development. In doing so, the technical solutions provide for accurate and reliable tracking, aggregation, and documentation of a process development, while conserving resources and improving computational efficiency and energy system consumption.

An aspect of the technical solutions described herein is directed to a system. The system can include one or more processors coupled with memory and configured (e.g., via instructions or code stored in the memory) to perform actions or operations. The one or more processors can be configured to receive, using one or more application programming interface calls, one or more streams of data from one or more digital channels. The one or more processors can be configured to detect, based on the one or more data streams input into one or more machine learning models, an indication of a modification to a process executed by an application. The one or more processors can be configured to trigger, responsive to the detection of the indication, a validation operation for the modification to the process. The one or more processors can be configured to compare a version of the application corresponding to the modification with a previous version of the application stored prior to the indication of the modification. The one or more processors can be configured to validate, based on the comparison, the indication of the modification to the process, the indication of the modification detected from the one or more data streams. The one or more processors can be configured to execute, responsive to the validation, an action.

The one or more digital channels can be associated with a plurality of applications including the application. The one or more processors can be configured to trigger the validation operation for the modification to the process to determine consistency of the modification across the plurality of applications via the one or more digital channels. The one or more processors can be configured to compare the version of the application corresponding to the modification with the previous version of the application using a structured representation of a state of the application maintained in a storage. The one or more processors can be configured to validate the indication of the modification by automatically confirming the modification as a valid change to the structured representation of the state of the application in the storage.

The one or more processors can be configured to identify, using the one or more machine learning models and one or more sources of information on the application, information indicative of a task implemented on the application. The task can include one or more of: a work item, a communication thread, a document update, or a code change associated with a project The one or more processors can be configured to identify, based on the information, one or more electronic accounts associated with the application based on metadata of the one or more electronic accounts indicative of at least one of a role, a project association, or an access permission. The one or more processors can be configured to select, based on the one or more electronic accounts, the one or more streams of data from the one or more data channels to detect the indication of the modification.

The one or more processors can be configured to identify one or more rules corresponding to the one or more digital channels, the one or more rules can define at least one of a format mapping, a field mapping, or a semantic correspondence between data received from different digital channels. The one or more processors can be configured to convert, based on the one or more rules, one or more formats of the one or more streams of data into a uniform format that normalizes data associated with the application across the one or more digital channels, wherein the uniform format is used to generate the version of the application and the previous version of the application. The one or more processors can be configured to receive a request to perform the action corresponding to a report on the application. The one or more processors can be configured to identify one or more identifiers for the one or more digital channels. The one or more processors can be configured to send the one or more application programming interface calls using the one or more identifiers for the one or more digital channels. The one or more processors can be configured to execute, responsive to the validation, the action to generate a notification of the modification for display.

The one or more processors can be configured to identify one or more electronic accounts associated with a digital channel of the one or more digital channels for exchanging information on development of the application. The one or more processors can be configured to detect the indication of the modification to the process based on an information exchanged via the digital channel. The information can include a mode of information of one or more of modes of information, the mode of information including at least one of: a string of characters, an image, an audio file or a video file and the one or more machine learning models trained on the one or more modes of information to detect a plurality of modifications comprising the modification.

The one or more processors can be configured to execute an automated workflow comprising a plurality of operations selected based on at least one of a type of the modification or a context of the modification. The plurality of operations can include at least one or two of: (i) generating a report element describing the modification for insertion into a report corresponding to the application, (ii) generating a notification of the modification for display, (iii) generating a request for additional information on the modification for presentation via a user interface and receiving the additional information, or (iv) updating a timeline of development of the application to include a representation of the modification. The at least one of the type of the modification can include at least one or more of: (i) a code change, (ii) a configuration change, (iii) a document update, or (iv) a change to a task or workflow state. The context of the modification can include at least one of: an electronic account associated with the modification, a project or application associated with the modification, a timestamp or sequence position of the modification, or a digital channel from which the modification was detected.

The one or more processors can be configured to identify the one or more machine learning models trained on a plurality of modes of information provided via a plurality of formats of a plurality of digital channels. The one or more processors can be configured to detect the modification based on the one or more data streams comprising one or more modes of information provided via one or more formats of the one or more data streams input into the one or more machine learning models.

The one or more processors can be configured to generate, based on the comparison and using the one or more machine learning models, a description of the modification for a report on the process executed by the application. The one or more processors can be configured to execute, responsive to the validation, the action to insert the description into a portion of the report corresponding to the application. The one or more processors can be configured to identify a first format of a first data of a first stream of the one or more streams of data. The one or more processors can be configured to identify a second format of a second data of a second stream of the one or more streams of data. The one or more processors can be configured to convert, using the one or more machine learning models, the first data and the second data into a uniform format, the uniform format used for the version of the application and the previous version of the application. The one or more processors can be configured to detect the indication of the modification based on the first data in the uniform format and the second data in the uniform format input into the one or more machine learning models.

The one or more processors can be configured to determine, responsive to the validation, a timeline of development of the application. The one or more processors can be configured to generate a representation of the modification for the timeline. The one or more processors can be configured to insert the representation of the modification into the timeline. The one or more processors can be configured to execute, responsive to the validation, the action to generate a document and insert the timeline with the representation of the modification into the document.

The one or more processors can be configured to generate, responsive to the validation, an output to provide via a user interface displayed on a client device, the output to request additional information on the modification. The one or more processors can be configured to receive, responsive to an input received via the user interface in response to the request, additional information on the modification. The one or more processors can be configured to generate, using the additional information and the one or more machine learning models, a portion of a report on the application. The one or more processors can be configured to determine, based on the one or more data streams input into the one or more machine learning models, a type of the modification. The one or more processors can be configured to execute, responsive to the validation, the action to generate a report indicating the type of the modification.

An aspect of the technical solutions is directed to a method. The method can include receiving, by one or more processors coupled with memory, using one or more application programming interface calls, one or more streams of data from one or more digital channels. The method can include detecting, by the one or more processors, based on the one or more data streams input into one or more machine learning models, an indication of a modification to a process executed by an application. The method can include triggering, by the one or more processors, responsive to the detection of the indication, a validation operation for the modification to the process. The method can include comparing, by the one or more processors, a version of the application corresponding to the modification with a previous version of the application stored prior to the indication of the modification. The method can include validating, by the one or more processors, based on the comparison, the indication of the modification to the process, the indication of the modification detected from the one or more data streams. The method can include executing, by the one or more processors, responsive to the validation, an action.

The method can include identifying, by the one or more processors, using the one or more machine learning models and one or more sources of information on the application, information indicative of an action implemented on the application. The method can include identifying, by the one or more processors, based on the information, one or more electronic accounts associated with the application. The method can include selecting, by the one or more processors, based on the one or more electronic accounts, the one or more streams of data from the one or more data channels to detect the modification.

The method can include identifying, by the one or more processors, one or more rules corresponding to the one or more digital channels. The method can include converting, by the one or more processors, based on the one or more rules, one or more formats of the one or more streams of data into a uniform format used to generate the version of the application and the previous version of the application. The method can include receiving, by the one or more processors, a request to perform the action corresponding to a report on the application. The method can include identifying, by the one or more processors, one or more identifiers for the one or more digital channels. The method can include sending, by the one or more processors, the one or more application programming interface calls using the one or more identifiers for the one or more digital channels. The method can include executing, responsive to the validation, the action to generate a notification of the modification for display.

The method can include identifying, by the one or more processors, one or more electronic accounts associated with a digital channel of the one or more digital channels for exchanging information on development of the application. The method can include detecting, by the one or more processors, the indication of the modification to the process based on an information exchanged via the digital channel. The information can include a mode of information of one or more of modes of information. The mode of information can include at least one of: a string of characters, an image, an audio file or a video file and the one or more machine learning models trained on the one or more modes of information to detect a plurality of modifications comprising the modification.

The method can include identifying, by the one or more processors, the one or more machine learning models trained on a plurality of modes of information provided via a plurality of formats of a plurality of digital channels. The method can include detecting, by the one or more processors, the modification based on the one or more data streams comprising one or more modes of information provided via one or more formats of the one or more data streams input into the one or more machine learning models.

An aspect of the technical solutions is directed to a non-transitory computer readable medium storing instructions. The instructions can cause the one or more processors to receive, using one or more application programming interface calls, one or more streams of data from one or more digital channels. The instructions can cause the one or more processors to detect, based on the one or more data streams input into one or more machine learning models, an indication of a modification to a process executed by an application. The instructions can cause the one or more processors to trigger, responsive to the detection of the indication, a validation operation for the modification to the process. The instructions can cause the one or more processors to compare a version of the application corresponding to the modification with a previous version of the application stored prior to the indication of the modification. The instructions can cause the one or more processors to validate, based on the comparison, the indication of the modification to the process, the indication of the modification detected from the one or more data streams. The instructions can cause the one or more processors to execute, responsive to the validation, an action.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system of a computing architecture for machine learning-based tracking and aggregation of application process development.

FIG. 2 illustrates a block diagram of an example computing system for implementing the embodiments of the present solution.

FIG. 3 illustrates an example configuration of a system for tracking and aggregation of application process development.

FIG. 4 is a flow diagram illustrating an example method for machine learning-based tracking and aggregation of application process development.

### DETAILED DESCRIPTION

Following below are more detailed descriptions of various concepts related to, and implementations of, methods, apparatuses, and systems for a computing architecture for machine learning based application development tracking and aggregation. The various concepts introduced above and discussed in greater detail below may be implemented in any of numerous ways.

Technical solutions described herein provide a machine learning-based tracking of application process development. The technical solutions also provide aggregation of application process development modifications implemented over time. As software applications become more complex and their development involves larger and decentralized teams, it becomes increasingly challenging to document the development process efficiently, timely, and accurately. For instance, when a team of designers develop an application, changes can be made by various team members to different parts of the application at any time. Tracking such changes can be time-consuming, challenging, as well as unreliable and prone to errors. In such instances, documenting of the application development can still be insufficient to timely inform the remaining team members of the lates modifications made, allowing for errors and waste of compute and energy resources, data mishandling and erroneous designs.

The technical solutions described herein overcome these challenges by providing a computing architecture for machine learning-based automated tracking and aggregation of application process development. The solutions can receive data streams from digital channels and use machine learning models to detect indications of modifications to processes. Validation operations can be utilized to validate detected indications of modifications. For example, the system can compare the modified application version with a previous version and validate the modification based on the comparison. Responsive to the validation, the system can execute actions, such as documenting the modification in the form of a report, a message, or an updated timeline of the project, thereby maintaining an aggregated knowledge base of the project development. In doing so, the technical solutions provide automated, accurate and reliable tracking, aggregation, and documentation of process development, while conserving resources and improving computational efficiency and energy system consumption.

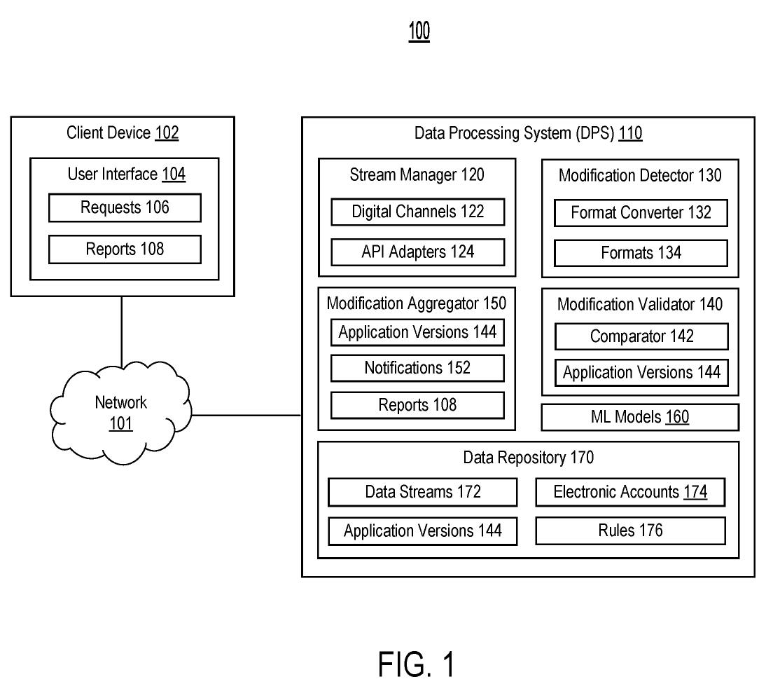

FIG. 1 depicts an example system 100 of a computing architecture for machine learning-based tracking and aggregation of application process development. System 100 can include, interface, or otherwise communicate with a client device 102 communicating with a data processing system (DPS) 110 over a network 101. The client device 102 can include a user interface 104 for receiving user requests 106 (e.g., for reports on the state of the project development) and displaying reports 108 (e.g., on the modifications made to the application or its process) generated by the data processing system 110. The data processing system 110 can include or operate a stream manager 120 to receive a stream of data from a digital channel. The data processing system 110 can include or operate a modification detector 130 to detect an indication of a modification to a process executed by an application, using for example, machine learning (ML) models 160. The data processing system 110 can include or operate a modification validator 140 to validate the indication of the modification, such as by comparing an application version previously stored in a data repository 170 with an application version corresponding to the modification. The data processing system 110 can include or operate a modification aggregator 150 to execute one or more actions, responsive to the validation.

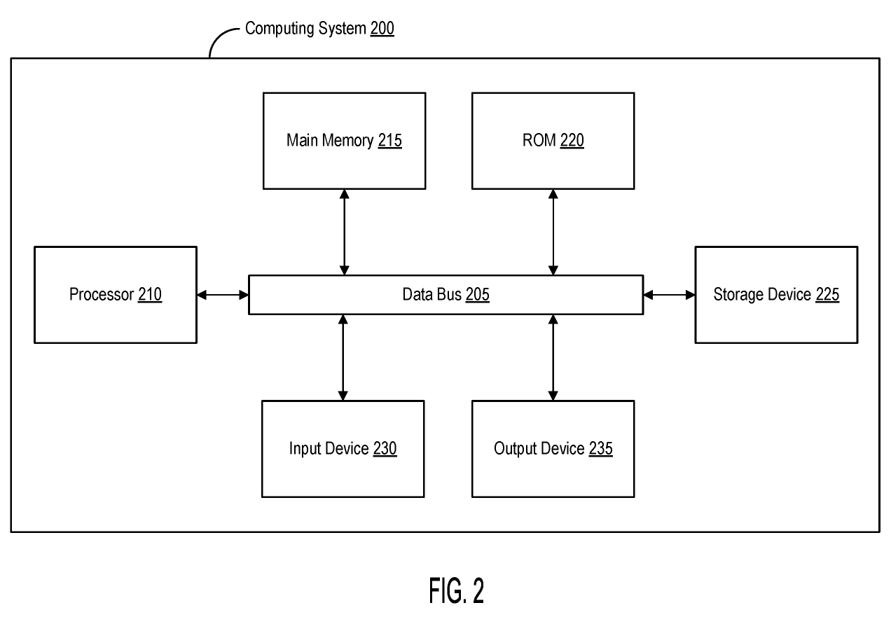

Data processing system 110 can include any combination of hardware and software for automated or machine learning based application development tracking and aggregation. The data processing system 110 can include the functionality for detection of modifications to an application being designed and generating reports 108 or notifications 152 of detected modifications. For example, a data processing system 110 can be implemented on a single device, such as a server implemented on a computing system 200, such as the one presented in FIG. 2. For example, a data processing system 110 can be distributed across a plurality of physical or virtual computing devices or systems, such as for example a cloud based service.

The data processing system 110 can include, provide, execute, operate or otherwise utilize one or more stream managers 120. A stream manager 120 can include any combination of hardware and software for managing receiving of streams of data (e.g., data streams 172) from one or more digital channels 122. The received data streams 172 can include various information that can indicate modifications being made to an application being developed. The stream manager 120 can receive data streams 172 from different types of sources, such as various design, communication or interactive tools or applications used by the team members for project development. The stream manager 120 can receive the data streams 172 using one or more application programming interface (API) calls. The API calls can be generated by the one or more API adapters 124 utilized by the stream manager to receive data streams 172 from the digital channels 122.

The data repository 170 can store, for one or more applications associated with one or more data channels 122, a structured representation of a state of an application (also referred to as an application state representation). The structured representation can include one or more state fields, objects, or records corresponding to the application, such as configuration data, workflow state, code or document identifiers, and one or more timestamps or version identifiers. Stored structured representations can be used to identify or keep track of modifications made to a design or a project. For instance, the structured representation can be updated over time to represent a most current application version 144 and can be retained to represent one or more previous application versions 144. This can allow the comparator 142 to compare the structured representation of a current version with the structured representation of a previous version. These comparisons can be utilized to identify or quantify the modifications made to the project or design.

The data processing system 110 can resolve heterogeneity (e.g., variability, inconsistency, differences, or non-uniformity) among digital channels 122. To do so, the data processing system 110 can generate, from each received data stream 172, a canonical event object in the uniform format 134. The canonical event object can include a defined set of fields such as (i) a channel identifier, (ii) an event type, (iii) an artifact identifier corresponding to an application artifact (e.g., code module identifier, configuration key, document identifier, or work item identifier), (iv) an actor identifier corresponding to an electronic account 174, (v) a timestamp or sequence position, and (vi) a payload comprising normalized field values. The format converter 132 can populate these fields by applying rules 176 that define at least one of a format mapping, a field mapping, or a semantic correspondence across different digital channels 122, thereby converting channel-specific representations into the uniform format 134 used by the data repository 170. The data processing system 110 can maintain the structured representation of the state of the application in the data repository 170. The data processing system 110 can update the structured representation of the state of the application using one or more canonical event objects by storing, for the application, a set of state fields or records indexed by the artifact identifiers and timestamps, such that application versions 144 correspond to snapshots of the structured representation after applying ordered subsets of canonical event objects.

The data processing system 110 can validate an indication of a modification using a verification technique in order to determine that the indication corresponds to an actual change in the structured representation of state, rather than merely a discussion of a potential change. The verification technique can include, for example, cross-channel corroboration, rules-based validation, or delta-based verification. For example, the modification detector 130 can generate a candidate modification event (e.g., inferred by one or more ML models 160) that identifies an expected affected artifact identifier and an expected change type. The comparator 142 can compute a delta set between a previous application version 144 and a modified application version 144 that includes one or more deltas each defined by a path or key into the structured representation, an operation type (add/modify/delete), and old and new values. The modification validator 140 can validate the candidate modification event by matching the expected artifact identifier and/or expected change type to at least one delta in the delta set and by determining that corroborating evidence exists in one or more canonical event objects derived from at least one data stream 172 (e.g., from a code repository channel, project management channel, or communication channel), thereby implementing a technical validation that fuses (i) a state-delta comparison with (ii) cross-channel normalized evidence. In some implementations, the stream manager 120 selects which data streams 172 to acquire and normalize based on metadata of electronic accounts 174 (e.g., role, project association, or access permission) so that ingestion, storage, and processing are scoped to authorized channels and authorized accounts, reducing unnecessary processing and improving efficiency while maintaining consistent state tracking across heterogeneous tools.

The validation operation described herein can provide a technical improvement to the functioning of the data processing system 110 by reducing false-positive modification detections and avoiding unnecessary downstream processing that would otherwise occur when heterogeneous digital channels 122 produce ambiguous, incomplete, or inconsistent signals. For example, rather than treating a machine-learning inference from a communication stream as sufficient, the modification validator 140 can anchor a candidate modification event inferred by one or more ML models 160 to (i) an identified delta in the structured representation of state (e.g., a delta having a path/key, an operation type, and old/new values) and (ii) corroborating evidence contained in one or more canonical event objects in the uniform format 134 from at least one additional digital channel 122. This ordered combination of delta-based verification and cross-channel corroboration improves the reliability of automated tracking in the presence of cross-channel ambiguity and reduces processor cycles, memory bandwidth, and storage writes that would otherwise be consumed by generating reports, notifications, or timelines for unconfirmed changes. By operating on canonical event objects that normalize heterogeneous channel-specific representations into a uniform, machine-parseable format 134, the system further improves computational efficiency by providing deterministic matching and indexing of events and deltas (e.g., by artifact identifier and sequence position), thereby reducing repeated parsing and ad hoc reconciliation operations across channel formats.

The data processing system 110 can provide additional technical improvements by scoping acquisition, normalization, and validation to authorized and relevant sources so that the computing architecture conserves network and compute resources while maintaining accurate state tracking. For example, the stream manager 120 can select which data streams 172 to acquire and normalize based on metadata of electronic accounts 174 (e.g., role, project association, or access permission), and can apply rules 176 to generate canonical event objects for channels and artifacts implicated by the candidate modification event (e.g., only the subset of digital channels 122 that are mapped to an affected artifact identifier). In this manner, the data processing system 110 can avoid continuous ingestion and normalization of unrelated streams, reduce excessive storage utilization from duplicative data, and improve efficiency by using a uniform validation pipeline for multiple tools and formats. These improvements can be are realized by the specific mechanisms described herein (e.g., uniform-format canonical event objects, structured state representations with version snapshots, delta-set comparisons, and corroboration rules), thereby providing a technical solution that improves operation of computer systems processing multi-channel development data.

For example, the data processing system 110 can receive a first data stream 172 from a messaging channel that includes text indicating that a configuration parameter was changed (e.g., “increase session timeout to 20 minutes”), while the data processing system 110 can receive a second data stream 172 from a code repository channel that includes a commit event modifying a configuration file. Using rules 176, the format converter 132 can generate two canonical event objects in the uniform format 134 that identify a common artifact identifier for the configuration parameter and associate each event with a timestamp and electronic account 174. The comparator 142 can compare the structured representation snapshots corresponding to application versions 144 immediately before and after the commit event and produce a delta set showing that the configuration parameter value changed from a first value to a second value. The modification validator 140 can validate the modification by matching the messaging-derived candidate modification event to the delta in the delta set and by treating the code-repository canonical event object as corroborating evidence, and the modification aggregator 150 can execute an action to generate a machine-readable message and/or a report element that records the validated change and updates a timeline representation. If the canonical event objects from different channels are inconsistent (e.g., the message indicates a different parameter value than the commit), the modification validator 140 can apply one or more rules 176 to prioritize evidence types (e.g., repository events over conversational events), request additional information via user interface 104, or defer validation until sufficient corroborating evidence is received, thereby improving reliability of automated tracking in the presence of cross-channel ambiguity.

In some implementations, the one or more digital channels 122 can be associated with a plurality of applications, such as applications whose process, development or modifications are monitored. The data processing system 110 can be configured to maintain, in data repository 170, a plurality of structured representations corresponding to the plurality of applications and to determine, via the modification validator 140, consistency of a modification across the plurality of applications. For example, a modification detected for a first application can be evaluated for consistency against one or more structured representations associated with one or more other applications, such as by determining whether the modification conflicts with, duplicates, or supersedes information represented in the other structured representations.

The stream manager 120 can include, utilize or operate one or more API adapters 124 to issue API calls to manage receiving of the data streams 172. An API adapter 124 can include any combination of hardware and software for connecting the data processing system 110 to external systems to retrieve data streams 172. The API adapter 124 can, for example, act as a bridge between a consuming application and an API to allow the consuming application to interact with the API in a more efficient and standardized manner, relative to interactions without an API adapter 124. The API adapter 124 can be used by the stream manager 120 to make API calls to digital channels 122 and retrieve their corresponding data streams 172. For example, one or more API adapters 124 can connect to digital channels 122 corresponding to communication platforms, code repositories, or project management tools to retrieve data on project activities. The API adapters 124 establish communications with various external applications (e.g., email applications, text messaging applications, video conferencing application, or computer code design application) to receive the data from such applications that may indicate modifications to the application being developed. The API adapters 124 can utilize, or operate with, a format converter 132 to convert the retrieved data streams 172 into a format 134 that can be processed by the data processing system 110 to facilitate the detection of indications of modifications.

The stream manager 120 can receive any type and form of streams of data. The streams of data, also referred to as data streams 172, can include any form of data provided to the data processing system 110 via digital channels 122. The streams of data, or data streams 172, can be referred to or include a data feed, a flow of data, a continuous flow of data, or sequence of packets. In some cases, the stream manager 120 can receive data as part of a batch upload. The data streams 172 can include data or information on project activities, such as interactions between client devices 102 associated with electronic accounts 174 (e.g., discussions between team members). The data streams 172 can include email or text message exchanges discussing actions taken on the application development. The data streams 172 can include code changes, meeting notes, and task updates. The data streams 172 can include video streams, audio streams, streams of text messages, data stream of emails between different design members, comments made in computer code design tools, or any other type and form of data. The data streams 172 can be converted by format converter 132 into a uniform format 134 for further processing by the data processing system 110. The data streams 172 can be stored in data repository 170 to maintain a record of the project development and provide access to historical data.

Data streams 172 can include various information that can include indications of modification to an ongoing project or an application being developed. An indication of modification can include any indication (e.g., data or string of characters) indicating that a modification or a change was made to an application being developed or a project being completed. An indication of modification can include, for example, a phrase, a term, a message or a sentence indicating that particular tasks or actions were implemented on the project. The indication of a modification can include any change or adjustment to a code, feature or a design of an application or any change or adjustment to a sequence of actions or operations that an application performs during its execution. The indication of a modification can include a phrase, name or a term, an image or video that can be indicative of a task or action being taken on an application or a process of an application being developed. The process of the application can include any sequence of actions or operations executed by the application during its development and usage.

The stream manager can receive the data streams 172 from any type and form of a digital channel 122. A digital channel 122 can include any combination of hardware and software for providing or generating data streams 172 that can be indicative of modifications to a project or the application being designed. The digital channels 122 can correspond to different design tools or applications utilized for project development. The data streams 172 provided via the digital channels 122 can include any data from design tools or applications utilized for application development. For instance, digital channel data can include, for example, video conference data, email application data, text messaging application data, computer code from computer code design tools, or any other data from applications or software tools used for project or application development. The digital channels 122 can include communication platforms, code repositories, and project management tools. The digital channels 122 can provide, responsive to API calls, data streams 172 that include information or indications on project activities, such as code changes, meeting notes, and task updates.

The stream manager 120 can manage the collection of the relevant data streams 172 that can include various types of indications of modifications made to the application being developed. For instance, the stream manager 120 can receive a request to perform the action corresponding to a report 108 on the application being developed. The stream manager 120 can identify one or more identifiers for the one or more digital channels. The stream manager 120 can utilize the API adapter 124 to send the one or more application programming interface calls using the one or more identifiers for the one or more digital channels 122. The stream manager 120 can then receive the requested data streams 172 from the digital channels 122 and provide the received data streams 172 to the modification detector 130 to detect the indications of modifications.

The data processing system 110 can include, provide, execute, operate or otherwise utilize one or more modification detectors 130. A modification detector 130 can include any combination of hardware and software for detecting indications of modifications of an application or its process using the data streams 172 of digital channels 122. The detected indication of the modification can include a change to a code, feature or a design of an application being developed, or a change to a sequence of actions or operations that an application performs during its execution. The modification detector 130 can detect the indication of the modification based on the received data streams 172 input into a machine learning (ML) model 160. The modification detector 130 can detect the presence of a modification to an application and in response to the detection, trigger a validation operation to validate the indication of the modification by initiating a call a modification validator 140. The modification detector 130 can utilize or operate a format converter 132 to convert different formats 134 of various data streams 172 into a uniform format 134. The format conversion can be implemented based on rules 176 and the reformatted data streams can be utilized for modification detection, validation and reporting (e.g., aggregation).

To detect the modification, the modification detector 130 can analyze data streams 172 received from digital channels 122 to identify changes in the project development. For example, modification detector 130 can utilize machine learning models 160 to detect indications of modifications to processes executed by applications. The modification detector 130 can interface or communicate with format converter 132 to convert the data streams 172 into a uniform format 134 for further processing. The modification detector 130 can use one or more ML models 160 and one or more sources of information on the application being developed (e.g., data streams 172) to identify data or information indicative of a task implemented on the application. For instance, the modification detector 130 can detect or identify, based on the information, one or more one or more electronic accounts 174 associated with the process of the application. The electronic accounts 174 can be electronic accounts of the team members assigned to a particular application development or a particular task development. The modification detector 130 can select, based on the one or more electronic accounts 174, the one or more data streams 172 from the one or more data channels to detect the indication of the modification.

The modification detector 130 can operate one or more format converters 132 to convert formats of incoming data streams 172. A format converter 132 can include any combination of hardware and software for converting data streams 172 from their original formats into a uniform format 134. The format converter 132 can be used to standardize the data received from different digital channels 122. For example, a format converter 132 can apply rules 176 to convert various formats 134 of data streams 172 into a consistent format used for modification detection, validation, and reporting. For instance, a format converter 132 can convert formats 134 of various data streams 172 from various digital channels 122 into a common format 134 of the data processing system 110, which can be utilized for maintaining application versions 144 and detecting modifications. The format converter 132 can handle data transformations, such as parsing and encoding, to ensure compatibility with the data processing system 110. The format converter 132 can work with modification detector 130 to prepare the data for modification detection and validation.

For instance, the modification detector 130 can identify, using one or more machine learning models 160 and one or more sources of information on the application, information indicative of a task implemented on the application. The task can be, or correspond to, one or more work objects, such as a work item, a communication thread, a document update, or a code change associated with a project. For example, the modification detector 130 can identify a work item update indicated in a project management tool data stream, identify a code change indicated in a code repository data stream, or identify a document update indicated in a document collaboration tool data stream.

In some implementations, the data repository 170 can store metadata for electronic accounts 174, such as metadata indicating at least one of a role, a project association, or an access permission. The stream manager 120 can identify, based on the task information identified by the modification detector 130, one or more electronic accounts 174 associated with the application and select one or more data streams 172 from one or more digital channels 122 based on the one or more electronic accounts 174. For example, the stream manager 120 can select, via API adapters 124, data streams 172 that are accessible to the electronic accounts 174 based on the stored access permissions, thereby limiting acquisition and processing of data to authorized channels and authorized account scopes.

Formats 134 of the data streams 172 processed by the modification detector 130 can include any type and form of data representation used in the project development process. A format can be a format of a data stream 172 from a digital channel 122, which can be converted to other formats 134 to represent the same or similar information. Formats 134 can vary depending on the source and type of data being transmitted through digital channels 122. For example, formats 134 can include text, JSON, XML, and other data formats used by communication platforms, code repositories, and project management tools. The formats 134 can be converted by format converter 132 into a uniform format 134 for further processing by the data processing system 110. For instance, formats 134 can be used to standardize the representation of project data, ensuring consistency and compatibility across different components of the system.

The modification detector 130 can utilize a format converter 132 identify a first format 134 of a first data of a first stream of the one or more data streams 172 and also identify a second format 134 of a second data of a second stream of the one or more data streams 172. The format converter 132 can convert the first data and the second data into a uniform format 134 of the data processing system 110. The format converter 132 can convert the formats 134 using the one or more ML models 160 trained to convert data formats 134 from the original formats into the uniform format 134 of the data processing system 110. The uniform format 134 can be used to generate the current application version 144 (e.g., the most recently updated version) and the previous application version 144 stored in the data repository 170.

The modification detector 130 can detect an indication of a modification based on textual data describing the modification. For instance, the modification detector 130 can identify one or more electronic accounts 174 associated with a digital channel 122 of the one or more digital channels 122 used to exchange information on development of the application. The electronic accounts 174 can correspond to electronic accounts of team members utilizing a text messaging or a file sharing application associated with the application being developed. The modification detector 130 can detect the indication of the modification to the process based on an information exchanged via the digital channel. The information can include a mode of information, such as a string of characters, an image, an audio file or a video file and the one or more machine learning models trained on the one or more modes of information to detect a plurality of modifications comprising the modification. The information exchanged can include, for example, text of an application, such as an email or a text messenger, describing a modification made to the application. Based on such a data stream 172 having such a textual description of the modification input into an ML model 160, the ML model 160 can detect the indication of the modification on behalf of the modification detector 130.

The modification detector 130 can detect the indication of the modification using a plurality of different data streams 172 from different digital channels 122 providing multiple indicia of a modification being made. For instance, the modification detector 130 can identify the one or more machine learning models trained on a plurality of modes of information provided via a plurality of formats of a plurality of digital channels. The modification detector 130 can detect the modification based on the one or more data streams comprising one or more modes of information provided via one or more formats of different data streams 172 input into the one or more ML models 160. Based on such multiple data streams 172 input into the ML model 160, the modification detector 130 can detect a first indicia of a modification in a first data stream (e.g., an email exchange describing a modification) and a second indicia of the same modification in a second data stream (e.g., a text message exchange describing implementation of the modification). In response to such multiple indicia of the modification across multiple data streams 172, the modification detector 130 can detect the indication of the modification.

The data processing system 110 can include, provide, execute, operate or otherwise utilize one or more modification validators 140. A modification validator 140 can include any combination of hardware and software for validating indications of modifications to application processes. The modification validator 140 can verify of validate detected indications of modifications using one or more ML models 160 trained to verify the indications of indications beyond a predetermined threshold for confidence level of determination. The modification validator 140 can verify or validate the indications of modifications using a comparator 142 to compare the modified (e.g., the most recent) application version 144 with a previous application version 144. For example, the modification validator 140 can utilize comparator 142 to perform the comparison and validate the modification based on the results of the comparison. The modification validator 140 can use machine learning models 160 to enhance the validation process, such as by cross-referencing multiple data streams 172 to identify supporting data across different digital channels 122, supporting the conclusion that a modification has been made. The modification validator 140 can generate validation reports 108 that provide detailed information on the validation results and any discrepancies detected.

The modification validator 140 can operate one or more comparators 142. A comparator 142 can include any combination of hardware and software for comparing different versions of an application (e.g., different application versions 144). For instance, a comparator 142 can be used to identify differences between the modified application version 144 and a previous version of the same application to identify a change or a modification. Comparator 142 can utilize one or more machine learning models 160 to compare various application versions 144 and identify, detect or determine existence of modifications. For example, comparator 142 can analyze the code, configuration, and other aspects of the application to detect changes. The comparator 142 can work with modification validator 140 to validate the modifications based on the comparison results. For instance, upon implementing a comparison between two different application versions 144, the comparator can identify the difference between the two application versions 144 and verify or validate if the difference is a modification to the design. The comparator 142 can generate comparison reports 108 that highlight the differences between the application versions 144 and provide insights into the changes made.

The modification validator 140 can utilize the comparator 142 to compare various application versions 144. An application version 144 can include any type and form of an instance or a copy of an application (e.g., computer code or design files of an application) that can be used by the comparator 142 to make comparisons and validate indications of modifications. Application versions 144 can represent different stages of the application being developed, such as initial versions, various modified versions, and a final or a most recent version of the application. For example, application versions 144 can include code, configuration files, and other artifacts related to the application. The application versions 144 can be compared by comparator 142 to identify modifications and validate an assessment that a change to the application has been made. Application versions 144 can be stored in data repository 170 to maintain a history of the project development and provide access to previous versions for reference.

The modification validator 140 can validate the indication of the modification using one or more rules 176. For example, the modification validator 140 can identify one or more rules 176 that can correspond to one or more digital channels 122. The modification validator 140 can utilize the format converter 132 to convert one or more formats 134 of the one or more data streams 172 into a uniform format 134 used to generate the version of the application and the previous version of the application. The converter 132 can convert the formats 134 into the uniform format based on the one or more rules 176. The modification validator 140 can input multiple data streams 172 that were converted into the common format into one or more ML models 160 trained to validate the indication of modification based on multiple data streams 172 from multiple digital channels 122. In response to inputting the multiple data streams 172 into the ML model 160, the ML model 160 can determine beyond a predetermined threshold of confidence (e.g., above 95 or 99% certainty) that the modification has been made to the application. For example, the ML model 160 can determine that a description of a modification to an application from a text messaging tool coincides with a computer code change for the same application. The ML model 160 can determine that the same group of electronic accounts 174 (e.g., the same group of designers) were involved in the text messaging exchange as well as in the computer code change. In response to these determinations, the ML model 160 can determine that the confidence level that the indication of the modification indicates a modification to the application exceeds a predetermined confidence threshold, thereby determining that the indication of modification is validated.

The modification validator 140 can validate indications of a modification in various ways. For instance, the modification validator 140 can validate an indication by automatically confirming the modification as a valid change to the structured representation of the state of the application stored in data repository 170. For example, comparator 142 can compare a structured representation corresponding to a version of the application with a structured representation corresponding to a previous version of the application and determine a set of deltas between the representations. The modification validator 140 can confirm validity of a delta based on one or more criteria, such as whether the delta is supported by one or more data streams 172 acquired from the digital channels 122, whether the delta is consistent with rules 176, or whether the delta is consistent with related structured representations maintained for other applications associated with the digital channels 122.

The data processing system 110 can include, provide, execute, operate or otherwise utilize one or more modification aggregators 150. A modification aggregator 150 can include any combination of hardware and software for aggregating validated modifications to applications or their processes and providing notifications 152 or reports 108 to the client devices 102. Modification aggregator 150 can include the functionality for collecting and consolidating the validated modifications into comprehensive reports 108 which can be shared with client devices 102 associated with electronic accounts 174 of the team members. For example, modification aggregator 150 can utilize machine learning models 160 to analyze the modifications and generate summaries of the modifications made the application. These summaries can be inserted into the notifications 152 or reports 108 provided to client devices 102. The modification aggregator 150 can work with data repository 170 to store and manage the aggregated modifications, ensuring the availability and integrity of the project data.

The modification aggregator 150 can generate notifications 152 to alert users of important updates or changes in the project. Notifications 152 can include any form of alerts or messages generated by the data processing system 110, such as notifications informing client devices 102 of team members (e.g., designers) that an update or a modification has been detected and identified. Notifications 152 can be used to inform users of important updates or changes in the project development. For example, notifications 152 can be generated by modification aggregator 150 to alert users of validated modifications and their impact on the project. The notifications 152 can be delivered to the client device 102 through the user interface 104, ensuring that users are promptly informed of any significant changes. Notifications 152 can be customized to include specific details and context relevant to the project development, such as designer who made the change, such as based on data associated with an electronic account 174 or information from the data stream 172 indicating the modification.

The modification aggregator 150 can generate reports 108. A report 108 can include any form of documentation or output generated by the data processing system 110. The reports 108 can provide users with detailed information on the project development, including updates on modifications and validation results. A report 108 can include one or more notifications 152 of one or more modifications. A report 108 can include a timeline of a series of modifications over time including the latest or most recent modification detected by the modification detector 130. For example, a report 108 can include a summary of one or more detected modifications, validation statuses, and aggregated project data. The reports 108 can be displayed on the client device 102 through the user interface 104, allowing users to review and analyze the project status. The reports 108 can be generated in various formats, such as PDF or HTML, can include graphical representations of modifications made to the application, including timelines of modifications and indications of types of modifications made along the project.

The modification aggregator 150 can generate a description of the modification for a report 108. The report 108 can describe the modification to a process executed by an application. The modification aggregator can generate the description based on the comparison between the current and prior application versions 144 and using the one or more ML models 160 that were trained to detect the differences and generate the description. In response to the validation of the indication of the modification by the modification validator 140, the modification aggregator 150 can execute the action to insert the description into a portion of the report 108 corresponding to the application.

The modification aggregator 150 can determine a timeline of development of the application in response to responsive to the validation. The modification aggregator 150 can generate a representation of the modification for the timeline and insert the representation of the modification into the timeline. The representation of the modification can include an icon or a link to a description indicating the timing of the modification made. The modification aggregator 150 can execute the action to generate a document and insert the timeline with the representation of the modification into the document. The modification aggregator 150 can generate the document and insert the representation into the timeline of the document responsive to the validation of the indication of the modification by the modification validator 140.

The modification aggregator 150 can generate an output to provide via a user interface 104 displayed on a client device 102. The output can include a request for additional information on the modification being indicated. The modification aggregator 150 receive, responsive to an input received via the user interface 104 in response to the request, additional information on the modification. The modification aggregator 150 can generate, using the additional information and the one or more machine learning models, a portion of a report on the application. For example, the modification aggregator 150 determine, based on the one or more data streams 172 input into the one or more ML models 160, a type of the modification being made. The type of the modification can include a modification to a setting, a modification to a computer code, a modification to order of operations or a modification to an operation being executed. The modification aggregator 150 can execute, responsive to the validation by the modification validator 140, the action to generate a report indicating the type of the modification for display in the user interface 104.

In some implementations, responsive to validation, the modification aggregator 150 executes the action to generate an output indicative of the modification. The output can comprise at least one of: (i) a notification 152 of the modification for display via user interface 104 on client device 102; (ii) a report element for insertion into a report 108 corresponding to the application; or (iii) a message in a machine‑readable format for automated processing by a computing process associated with one or more applications corresponding to the digital channels 122. In some implementations, the action comprises executing an automated workflow that includes a plurality of operations selected based on at least one of a type of the modification or a context of the modification, such as by selecting operations responsive to whether the modification corresponds to a code change, a configuration change, a document update, or a change to a task or workflow state, and further based on context including an electronic account 174 associated with the modification, a project association, or a timestamp associated with the modification.

Client device 102 can include any combination of hardware and software for interacting with the data processing system 110 over a network 101. A client device 102 can be a computer, a laptop, a work-station or a tablet utilized by a person designing an application being modified or updated. For instance, a client device 102 can be used by team members designing an application or developing a project (e.g., the designers) to input requests 106 for reports or updates on the documentation of the project development. A client device 102 can operate a user interface 104 to receive and send requests 106 to the data processing system 110 to retrieve the latest project reports 108. The client device 102 can also utilize the user interface 104 to display the reports 108 generated by the data processing system 110, providing users with real-time updates on the project status.

User interface 104 can include any combination of hardware and software for receiving user inputs and displaying outputs (e.g., reports 108 or notifications 152). User interface 104 can be used to receive user requests 106 for reports or updates on the project development. User interface can include any type of an interface, such as a graphical user interface for displaying various notifications 152 or reports 108. For example, user interface 104 can display a dashboard that allows users to select specific reports 108 or updates they wish to view or for displaying notifications 152 when a process of the designed application is updated. The user interface 104 can also provide interactive elements, such as buttons and menus, to facilitate user interaction with the system. The user interface 104 can display notifications 152 generated by the data processing system 110 to alert users of client devices 102 of modifications made to the application or the project.

Requests 106 can include any form of user input or query directed to the data processing system 110. Requests 106 can be used to retrieve specific information or reports 108 related to the project development. For example, requests 106 can be generated by users through the user interface 104, requesting the latest project documentation or status updates with respect to a project (e.g., an application or a process being designed or updated). The data processing system 110 can process these requests 106 and generate the corresponding reports 108.

Network 101 can include any combination of hardware and software for facilitating communication between the client device 102 and the data processing system 110. Network 101 can be used to transmit requests 106 from the client device 102 to the data processing system 110 and to deliver reports 108 back to the client device 102. For example, network 101 can include wired or wireless communication channels, such as wireline connections, the internet or a local area network (LAN). The network 101 can also provide secure communication protocols to ensure the integrity and confidentiality of the transmitted data. Network 101 can support real-time communication, allowing for timely updates and interactions between the client device 102 and the data processing system 110.

Data repository 170 can include any combination of hardware and software for storing, providing access to, or managing project data. Data repository 170 can store any combination of data streams 172, electronic accounts 174, or application versions 144 related to the project development of one or more applications or their processes. For example, data repository 170 can maintain a history of the project development by storing previous application versions 144 and their associated modifications. The data repository 170 can also provide access to the stored data for other components of the data processing system 110, such as modification detector 130 and modification validator 140. The data repository 170 can store rules 176 that can be utilized by the data processing system 110 to provide data security, format conversions, and protocol compliance.

Electronic accounts 174 can include any form of user accounts associated with the project development. Electronic accounts 174 can be used to identify and authenticate users involved in the project. Electronic accounts 174 can be used to identify designers or persons who made the change to the design, as well as persons who should be notified of the change (e.g., team members). For example, electronic accounts 174 can be associated with different projects, application developments, team members and their respective roles in the project. The electronic accounts 174 can also be used to track user activities and contributions to the project development. The electronic accounts 174 can be stored in data repository 170 and used by other components of the data processing system 110, such as modification detector 130 and modification validator 140, to ensure accurate tracking and documentation of user actions.

Rules 176 can include any combination of policies and protocols for managing data security, format conversions, and protocol compliance. A rule 176 can be used converting a first format of a data stream 172 received from a digital channel 122 into a common format 134 of a modification aggregator 150 to be used for maintaining changes to the project or application design. Rules 176 can be used to ensure the integrity and confidentiality of the data processed by the data processing system 110. For example, rules 176 can define the security measures for accessing and transmitting data streams 172 from digital channels 122. The rules 176 can also specify the format conversions to be applied by format converter 132 to standardize the data. The rules 176 can be used to enforce protocol compliance and scheduling of reports 108 and notifications 152, ensuring that the project development process adheres to established guidelines.

In some implementations, rules 176 define at least one of a format mapping, a field mapping, or a semantic correspondence between data received from different digital channels 122. For example, rules 176 can map a first field name used by a first tool to a second field name used by a second tool, can map a first event type used by a first tool to a second event type used by a second tool, or can map semantically equivalent objects across tools (e.g., mapping an “issue,” “ticket,” or “task” to a common work object type). The format converter 132 can convert incoming data streams 172, based on rules 176, into one or more normalized representations in a uniform format 134 that are stored in data repository 170 and used to generate the current application version 144 and one or more previous application versions 144.

ML models 160 can include any combination of machine learning algorithms and techniques for analyzing and processing data streams 172. ML models 160 can be used to detect modifications to application processes and validate the changes. For example, ML models 160 can analyze data streams 172 received from digital channels 122 to identify indications of modifications. The ML models 160 can also be used by modification validator 140 to enhance the accuracy of the validation process. The ML models 160 can be utilized by modification aggregator 150 to generate summaries and reports 108 of the validated modifications, providing users with detailed insights into the project development.

ML models 160 can include any type and form of artificial intelligence (AI) models implementing any AI techniques. For instance, ML models 160 can include generative AI models trained or designed to learn patterns and make predictions from data, including models that are trained to generate new content resembling distributions of data on which they are trained. ML models 160 can include generative AI models constructed using variational autoencoders (VAEs), designed to learn latent representations of data and generate new samples based on the representations. ML models 160 can include generative AI models constructed using generative adversarial networks (GANs) that can use a generator and a discriminator to produce a determination or an output. ML models 160 can include generate AI models constructed using transformers, which can be designed to learn features or inferences based on sequence-to-sequence capabilities. ML models 160 can utilize generative AI functionality to train and adapt to user characteristics, preferences or device specifications.

ML models 160 can include generative models, such as generative adversarial networks (GANs), natural language processing (NLP) models, such as GPT (Generative Pre-trained Transformer) models, or transformer-based model architectures configured to generate new instances of data based on patterns learned during training. ML models 160 can be trained to detect changes in application versions 144 and identify the differences (e.g., detect the modifications). ML models 160 can be trained to identify the authors of the modification based on the contents of the data stream 172 and identify the users associated with particular electronic accounts 174 to notify with notifications 152 or reports 108.

ML models 160 can include LLMs that can be trained to detect or identify indications of modifications from various data in digital channels 122. ML models 160 can be trained to monitor data streams 172 of various digital channels 122 and detect or identify the indications of modifications. The ML models 160 can be trained to trigger or utilize a modification validator 140 in response to detecting an indication of modification (e.g., a phrase or statement) indicative of a modification being made to a process of an application.

FIG. 2 illustrates a block diagram of a computing system 200 for implementing the embodiments of the present solution, in accordance with embodiments. FIG. 2 illustrates a block diagram of an example computing system 200, which can also be referred to as the computer system 200. Computing system 200 can be used to implement elements of the systems and methods described and illustrated herein, such as for example, commands, instructions or data described herein. Computing system 200 can be included in, provide support for, or run any device (e.g., client device 102 or data processing system 110), or any other feature or component described herein.

Computing system 200 can include at least one bus data bus 205 or other communication device, structure or component for communicating information or data. Computing system 200 can include at least one processor 210 or processing circuit coupled to the data bus 205 for executing instructions or processing data or information. Computing system 200 can include one or more processors 210 or processing circuits coupled to the data bus 205 for exchanging or processing data or information along with other computing systems 200. Computing system 200 can include one or more main memories 215, such as a random access memory (RAM), dynamic RAM (DRAM), cache memory or other dynamic storage device, which can be coupled to the data bus 205 for storing information, data and instructions to be executed by the processor(s) 210. Main memory 215 can be used for storing information (e.g., data, computer code, commands or instructions) during execution of instructions by the processor(s) 210.

Computing system 200 can include one or more read only memories (ROMs) 220 or other static storage device 225 coupled to the bus 205 for storing static information and instructions for the processor(s) 210. Storage devices 225 can include any storage device, such as a solid state device, magnetic disk or optical disk, which can be coupled to the data bus 205 to persistently store information and instructions.

Computing system 200 may be coupled via the data bus 205 to one or more output devices 235, such as speakers or displays (e.g., liquid crystal display or active matrix display) for displaying or providing information to a user. Input devices 230, such as keyboards, touch screens or voice interfaces, can be coupled to the data bus 205 for communicating information and commands to the processor(s) 210. Input device 230 can include, for example, a touch screen display (e.g., output device 235). Input device 230 can include a cursor control, such as a mouse, a trackball, or cursor direction keys, for communicating direction information and command selections to the processor(s) 210 for controlling cursor movement on a display.

The processes, systems and methods described herein can be implemented by the computing system 200 in response to the processor 210 executing an arrangement of instructions provided via main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors 210 in a multi-processing arrangement may also be employed to execute the instructions contained in main memory 215. Hard-wired circuitry can be used in place of or in combination with software instructions together with the systems and methods described herein. Systems and methods described herein are not limited to any specific combination of hardware circuitry and software.

Although an example computing system has been described in FIG. 2, the subject matter including the operations described in this specification can be implemented in other types of digital electronic circuitry, or in computer software, firmware, or hardware, including the structures disclosed in this specification and their structural equivalents, or in combinations of one or more of them.

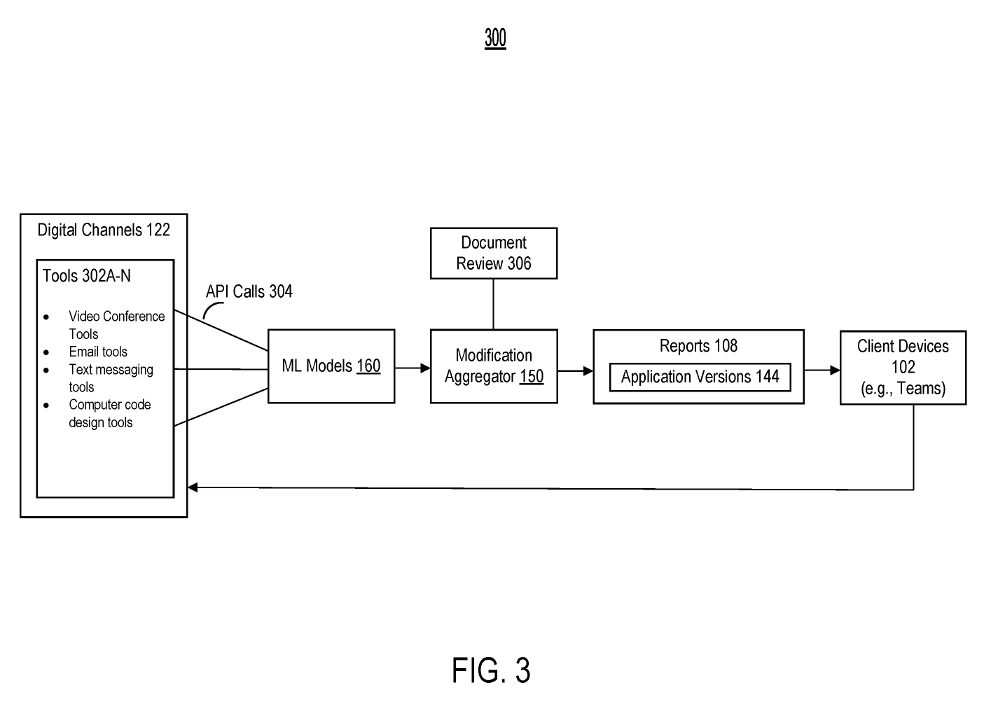

FIG. 3 illustrates an example configuration 300 of a system for tracking and aggregation of application process development. Example configuration 300 can include a number of digital channels 122 from various tools 302A-N, such as video conference tools or applications, email tools or applications, text messaging tools or applications or computer code design tools or applications. API adapters 124 can utilize API calls 304 to acquire various data streams 172 from any one or more digital channels 122 and the corresponding tools 302. These data streams 172 can be input into ML models 160 trained to detect or identify indications or information indicative of modifications made to an ongoing project, such as a process of an application being developed.

Outputs of ML models 160 (e.g., indications of detected modifications) can be input into a modification aggregator 150 which can work together with a modification validator 140 validate the indication of the modification. A document review 306 application can be provided to allow for a human in the loop review of the indication of the modification. In some instances, the document review 306 can be utilized for validation of the indication of the modification to the process. In some instances, ML model 160 can be utilized to validate the indication of the modification. In some instances, a comparator 142 can be utilized to compare a prior application version 144 with a most current application version 144 to determine or detect the presence of the indication of the modification.

The modification aggregator 150 can generate, based on the detected or identified modification, the latest or most recently updated application version 144. The modification aggregator 150 can generate reports 108 based on one or more application versions 144 and provide notifications 152 of the modifications made in the report. The reports 108 can include any number or type of notifications 152, such as textual summaries or descriptions of the modifications, timelines of the modifications or illustrations (e.g., graphs or plots) of various data corresponding to the modifications made. The reports 108 can be generated in real-time in response to detection of an indication of modification or responsive to a request. The reports 108 can be sent to client devices 102 of the team members (e.g., designers) to notify all of the team members of the modification.

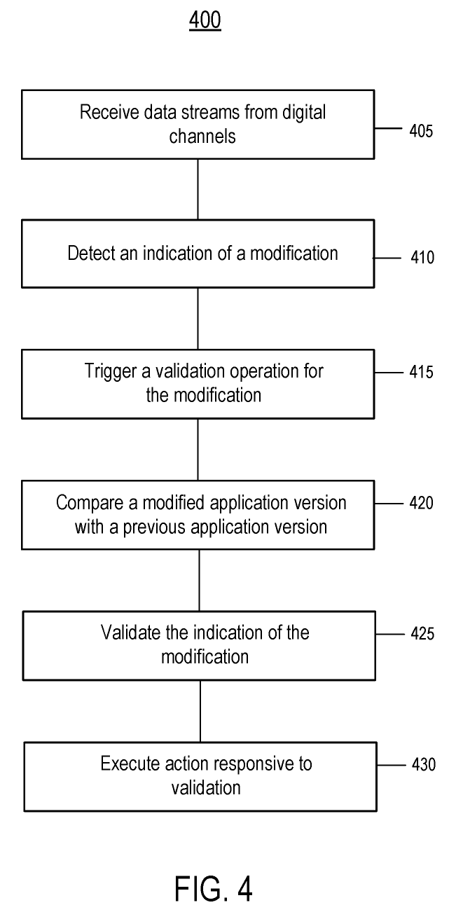

FIG. 4 illustrates a flow diagram of a method 400 for machine learning-based tracking and aggregation of application process development. The method 400 can be a computer-implemented method performed by one or more systems or components depicted in FIGS. 1-3, including, for example, a data processing system 110 of FIG. 1 implemented using processors 210 configured to perform the functionalities of the data processing system 110 based on instructions, computer code or data stored on memory or storage (e.g., 215, 220 or 225) of a computing system 200. At a high level, method 400 can include acts 405-430. At 405, the method can receive one or more data streams from one or more digital channels. At 410, the method can detect an indication of a modification. At 415, the method can trigger a validation operation for the modification. At 420, the method can compare a modified application version with a previous application version. At 425, the method can validate the indication of the modification. At 430, the method can execute one or more actions responsive to the validation.

At 405, the method can receive one or more data streams from one or more digital channels. The method can include one or more processors coupled with memory executing a data processing system. The one or more processors can receive, using one or more application programming interface calls, one or more streams of data from one or more digital channels. For instance, a stream manager of the data processing system can utilize API adapters to generate or issue one or more API calls to request access to, or to cause the data processing system to receive, one or more data streams from one or more digital channels. The digital channels can correspond to one or more software tools or applications utilized for design or development of an application or a project.

The one or more processors can identify information indicative of a task or an action implemented on the application. The one or more processors can identify the information indicative of the task or action using the one or more machine learning models and one or more sources of information on the application (e.g., data streams from one or more data channels). The task or action can include any action or task that can alter, adjust, or modify operation or execution of an application being developed, such as a change to a computer code, adjustment to a setting or arrangement of operations or any other action changing a process or operation of the application. The task can include a work item, a communication thread, a document update, or a code change associated with a project

The one or more processors can execute the stream manager to identify, based on the information, one or more one or more electronic accounts associated with the process of the application. The one or more electronic accounts can be identified based on metadata of the one or more electronic accounts indicative of at least one of a role, a project association or an access permission. The stream manager can select, based on the one or more electronic accounts (e.g., associated with client devices developing the application or the project), the one or more streams of data from the one or more data channels to detect the indication of the modification. For instance, the stream manager can receive a request to perform the action corresponding to a report on the application. The action can include a request to generate a report on the changes made to the application or project within a predetermined time period (e.g., within the last week, month or a year). The stream manager can identify one or more identifiers for the one or more digital channels. The stream manager can utilize one or more API adapters to send the one or more application programming interface calls using the one or more identifiers for the one or more digital channels to receive the data streams for detecting any modifications.

At 410, the method can detect an indication of a modification. The method can include the one or more processors detecting, based on the one or more data streams input into one or more machine learning models, an indication of a modification. The modification can be a modification to a process executed by an application. The modification can be a modification or a change to the application's codebase, such as adding new features, changing computer code or operations of existing features or fixing bugs. The modification can be an update to the application's configuration settings, optimizing performance or enhancing security. The modification can be an alteration to the user interface, improving user experience or accessibility. The modification can be a change in the application's integration with external systems, ensuring compatibility and seamless data exchange.

The method can include the modification detector identifying one or more rules corresponding to the one or more digital channels and convert, based on the one or more rules, one or more formats of the one or more streams of data. The method can include identifying one or more rules defining at least one of a format mapping, a field mapping or a semantic correspondence between data received from different digital channels. For example, the one or more rules can define a mapping that associates a first field or object type used by a first digital channel with a second field or object type used by a second digital channel, such as mapping a task, ticket, or issue represented in different formats by different tools to a common work object, or mapping different event identifiers, status values, or metadata fields used by different digital channels to a common semantic representation used by the data processing system. For example, various formats of various data streams from data channels can be converted (e.g., using machine learning models trained on data of various data stream formats and a uniform format of the data processing system) into a uniform format that can be used to generate the version of the application and the previous version of the application. The uniform format can be utilized to compare various versions of the applications in order to detect or identify modifications.

The method can include the modification detector identifying one or more electronic accounts associated with a digital channel of the one or more digital channels for exchanging information on development of the application. The modification detector can detect the indication of the modification to the process based on an information exchanged via the digital channel. The information can include a mode of information of one or more of modes of information. The mode of information can include at least one of: a string of characters, an image, an audio file or a video file and the one or more machine learning models trained on the one or more modes of information to detect a plurality of modifications comprising the modification. The information can include, for example, a series of emails discussing changes to the application’s architecture. The information can include instant messaging conversations detailing updates to the user interface design. The information can include meeting notes summarizing decisions made during project planning sessions. The information can include code indicating modifications to the application's source code.

The method can include the modification detector identifying the one or more machine learning models trained on a plurality of modes of information provided via a plurality of formats of a plurality of digital channels. The modification detector can detect the modification based on the one or more data streams comprising one or more modes of information provided via one or more formats of the one or more data streams input into the one or more machine learning models. For example, the modification detector can analyze text data from emails and instant messages to identify changes in project requirements. The modification detector can process audio recordings from meetings to detect discussions about modifications to the application’s architecture. For instance, the modification detector can evaluate video files from design review sessions to identify visual changes in the user interface of an application or any adjustments to any feature of the application or a project being developed or completed. The modification detector can analyze images of whiteboard sketches to detect updates to the application's workflow.

The method can include a format converter of the modification detector identifying a first format of a first data of a first stream of the one or more streams of data. The format converter can identify a second format of a second data of a second stream of the one or more streams of data. The format converter can utilize one or more machine learning models trained on detecting and identifying various formats of data streams from various digital channels and converting them into the common format of the data processing system. The format converter can convert, using the one or more machine learning models, the first data and the second data into a uniform format, the uniform format used for the version of the application and the previous version of the application. The modification detector can detect the indication of the modification based on the first data in the uniform format and the second data in the uniform format input into the one or more machine learning models. For instance, the modification detector can utilize machine learning models to identify an indication of the modification based on various data streams of various formats input into one or more machine learning models. In some implementations, the modification detector can convert the formats of different data streams into a common format and then insert the data streams converted into the common format as inputs into the one or more machine learning models to identify or detect the indications of the modifications.

At 415, the method can trigger a validation operation for the modification. The method can include the one or more processors triggering a validation operation for the modification to the process, responsive to the detection of the indication. For instance, the modification detector can trigger a modification validator to validate one or more indications of modifications to an application development or a process of an application. For example, the modification detector can trigger a modification validator to validate a detected change in the application's codebase, such as the addition of a new feature, modification of an existing feature, or a computer code correction (e.g., a bug fix). The modification validator can be triggered to validate updates to the application's configuration settings, such to validate the changes made (e.g., that the changes were indeed made or that the changes do not introduce any security vulnerabilities). For example, the method can include triggering the validation operation for the modification to the process to determine consistency of the modification across the plurality of applications being monitored, via the one or more digital channels.

The modification detector can trigger the modification validator to validate the existence of the modification or the quality of the modification. For example, the modification detector can trigger the modification validator to validate the alterations to the user interface, such as to validate the information that the modification was indeed made or to confirm that the changes improve the user interface or the user experience at the user interface without causing any usability issues. The modification validator can be triggered to validate changes in the application's integration with external systems, to verify that the change to the application’s integration with the external system is made as well as to validate the compatibility and seamless data exchange due to the change. The modification detector can trigger the modification validator to validate modifications based on predefined rules and standards, such as to check or ensure the compliance with project requirements, performance or operational parameters.

At 420, the method can compare a modified application version with a previous application version. The method can include the one or more processors comparing a version of the application corresponding to the modification with a previous version of the application stored prior to the indication of the modification. For instance, the comparator of the modification validator can compare the most recent version of the application with a second most recent version to identify or validate the changes or modifications made. The comparison can involve analyzing the code, configuration files, and other artifacts associated with the application versions. The comparator can identify differences between the versions, such as added, modified, or deleted code segments, and generate a detailed report of the comparison results. For example, the comparator can compare the version of the application corresponding to the modification with the previous version of the application using a structured representation of a state of the application that can be stored or maintained in a storage device.

The method can include the comparator validating the modifications based on the comparison results. For example, the comparator can compare, determine or validate that the changes made to the application's codebase are consistent with the project's requirements and do not introduce errors. The comparator can compare, determine or validate that updates to the application's configuration settings are correctly implemented and do not compromise the application's security. The comparator can compare, determine or validate that alterations to the user interface improve or do not adversely impact the user experience without causing any usability issues. The comparator can compare, determine or validate that changes in the application's integration with external systems are compatible and exchange data seamlessly.

At 425, the method can validate the indication of the modification. The method can include the one more processors validating, based on the comparison, the indication of the modification to the process. The indication of the modification can be detected from the one or more data streams. For example, the validation can involve confirming that the detected modification aligns with the changes identified in the comparison of the application versions. The validation process can also include verifying that the modification adheres to predefined rules and standards, ensuring compliance with project requirements. For instance, the validation can involve checking the consistency of the modification with other related changes to maintain overall coherence in the application development. For instance, the method can include validating the indication of the modification by automatically confirming the modification as a valid change to the structured representation of the state of the application in the storage.

The method can include generating a validation report based on the validation results. The validation report can provide a detailed summary of the validated modifications, highlighting any discrepancies or issues detected during the validation process. The report can include recommendations for addressing any identified issues, ensuring that the modifications are accurately documented and implemented. The validation report can be used to inform team members (e.g., client devices associated with client accounts corresponding to the application or project being developed) of the validation results. The validation report can be generated in various formats, such as PDF or HTML, to facilitate sharing and distribution among team members.

At 430, the method can execute one or more actions responsive to the validation. The method can include the one or more processors executing an action, responsive to the validation. The action can include, for example, generating a report of the validated modifications, updating a project timeline to reflect the modifications made, such as in view of expected timeline or deadlines, sending notifications to relevant design members (e.g., client accounts associated with the project), creating a backup of the modified application versions, initiating a deployment process for the updated application, logging validation results for future reference, triggering or requesting testing procedures to verify the stability of the modifications, updating the project documentation to include the validated changes, or adjusting resource allocation based on the validated modifications.

The method can include the modification aggregator executing the action to generate a notification of the modification for display, responsive to the validation at act 425. The method can include executing the action to generate an output that include at least one of: a notification of the modification for display, a report element for insertion into a report corresponding to an application associated with a data channel, or a message or transmission for automated processing by a computing processing that corresponds to an application associated with a channel. For example the method can include the modification aggregator generating, based on the comparison and using the one or more machine learning models, a description of the modification for a report on the process executed by the application. The modification aggregator can execute, responsive to the validation, the action to insert the description into a portion of the report corresponding to the application. The modification aggregator can send the generated report to the team member client accounts that are associated with the application whose process is modified, such as by sending email to the email addresses associated with the client accounts of the team members for the project or the application being developed.

The method can include executing an action that includes executing an automated workflow or a computational process having a plurality of operations. The operation can be selected based on at least one of a type of the modification or a context of the modification. The operations can include one or more of: generating a report element describing the modification for insertion into a report corresponding to the application, generating a notification of the modification for display, generating a request for additional information on the modification for presentation via a user interface and receiving the additional information, updating a timeline of development of the application to include a representation of the modification. The modification can include one or more of: a code change, a configuration change, a document update, or a change to a task or workflow state. The context of the modification can include at least one of: an electronic account associated with the modification, a project or application associated with the modification, a timestamp or sequence position of the modification, or a digital channel from which the modification was detected.

The method can include the modification aggregator determining, responsive to the validation, a timeline of development of the application; generate a representation of the modification for the timeline. The modification aggregator can insert the representation of the modification into the timeline and execute, responsive to the validation, the action to generate a document, as well as insert the timeline with the representation of the modification into the document. The modification aggregator can generate, responsive to the validation, an output to provide via a user interface displayed on a client device. The output can request additional information on the modification. The modification aggregator can receive, responsive to an input received via the user interface in response to the request, additional information on the modification and can generate at least a portion of a report on the application. The at least a portion of the report can be generated using the additional information and the one or more machine learning models.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be a cloud storage product or service, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses.

Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computer device”, “component” or “data processing system” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present description.

For example, a computer system 200 described in FIG. 2 can be used in conjunction with, instead of, or together with system 100 or its system components, and vice versa. Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
one or more processors, coupled with memory, to:
receive, using an application programming interface call, one or more streams of data from one or more digital channels;
detect, based on the one or more streams of data input into one or more machine learning models, an indication of a modification to a process executed by an application;
trigger, responsive to the detection of the indication, a validation operation for the modification to the process;
compare a version of the application corresponding to the modification with a previous version of the application stored prior to the indication of the modification;
validate, based on the comparison, the indication of the modification to the process, the indication of the modification detected from the one or more streams of data; and
execute, responsive to the validation, an action.

2. The system of claim 1, wherein the one or more digital channels are associated with a plurality of applications including the application, and wherein the one or more processors further:
trigger the validation operation for the modification to the process to determine consistency of the modification across the plurality of applications via the one or more digital channels;
compare the version of the application corresponding to the modification with the previous version of the application using a structured representation of a state of the application maintained in a storage; and
validate the indication of the modification by automatically confirming the modification as a valid change to the structured representation of the state of the application in the storage.

3. The system of claim 1, wherein the one or more processors further:
identify, using the one or more machine learning models and one or more sources of information on the application, information indicative of a task implemented on the application including one or more of: a work item, a communication thread, a document update, or a code change associated with a project;
identify, based on the information, one or more electronic accounts associated with the application based on metadata of the one or more electronic accounts indicative of at least one of a role, a project association, or an access permission; and
select, based on the one or more electronic accounts, the one or more streams of data from the one or more data channels to detect the indication of the modification.

4. The system of claim 1, wherein the one or more processors further:
identify one or more rules corresponding to the one or more digital channels, the one or more rules defining at least one of a format mapping, a field mapping, or a semantic correspondence between data received from different digital channels;
convert, based on the one or more rules, one or more formats of the one or more streams of data into a uniform format that normalizes data associated with the application across the one or more digital channels, wherein the uniform format is used to generate the version of the application and the previous version of the application.

5. The system of claim 1, wherein the one or more processors further:
receive a request to perform the action corresponding to a report on the application;
identify one or more identifiers for the one or more digital channels;
send the application programming interface call using the one or more identifiers for the one or more digital channels; and
execute, responsive to the validation, the action to generate an output indicative of the modification, the output comprising at least one of:
(i) a notification of the modification for display;
(ii) a report element for insertion into a report corresponding to the application; or
(iii) a message for automated processing by a computing process corresponding to one or more applications associated with the one or more digital channels.

6. The system of claim 1, wherein the one or more processors further:
identify one or more electronic accounts associated with a digital channel of the one or more digital channels for exchanging information on development of the application; and
detect the indication of the modification to the process based on an information exchanged via the digital channel, wherein the information includes a mode of information including at least one of: a string of characters, an image, an audio file or a video file and the one or more machine learning models trained on the one or more modes of information to detect a plurality of modifications comprising the modification.

7. The system of claim 1, wherein executing the action comprises executing an automated workflow comprising a plurality of operations selected based on at least one of a type of the modification or a context of the modification, the plurality of operations comprising at least two of:
(i) generating a report element describing the modification for insertion into a report corresponding to the application;
(ii) generating a notification of the modification for display;
(iii) generating a request for additional information on the modification for presentation via a user interface and receiving the additional information; or
(iv) updating a timeline of development of the application to include a representation of the modification.

8. The system of claim 7, wherein the at least one of the type of the modification comprises at least one of:
(i) a code change;
(ii) a configuration change;
(iii) a document update; or
(iv) a change to a task or workflow state;
and wherein the context of the modification comprises at least one of:
(a) an electronic account associated with the modification;
(b) a project or application associated with the modification;
(c) a timestamp or sequence position of the modification; or
(d) a digital channel from which the modification was detected.

9. The system of claim 1, wherein the one or more processors further:
identify the one or more machine learning models trained on a plurality of modes of information provided via a plurality of formats of a plurality of digital channels; and
detect the modification based on the one or more streams of data comprising one or more modes of information provided via one or more formats of the one or more streams of data input into the one or more machine learning models.

10. The system of claim 1, wherein the one or more processors further:
generate, based on the comparison and using the one or more machine learning models, a description of the modification for a report on the process executed by the application; and
execute, responsive to the validation, the action to insert the description into a portion of the report corresponding to the application.

11. The system of claim 1, wherein the one or more processors further:
identify a first format of a first data of a first stream of the one or more streams of data;
identify a second format of a second data of a second stream of the one or more streams of data;
convert, using the one or more machine learning models, the first data and the second data into a uniform format, the uniform format used for the version of the application and the previous version of the application; and
detect the indication of the modification based on the first data in the uniform format and the second data in the uniform format input into the one or more machine learning models.

12. The system of claim 1, wherein the one or more processors further:
determine, responsive to the validation, a timeline of development of the application;
generate a representation of the modification for the timeline;
insert the representation of the modification into the timeline; and
execute, responsive to the validation, the action to generate a document that includes the timeline with the representation of the modification.

13. The system of claim 1, wherein the one or more processors further:
generate, responsive to the validation, an output to provide via a user interface displayed on a client device, the output to request additional information on the modification;
receive, responsive to an input received via the user interface in response to the request, additional information on the modification; and
generate, using the additional information and the one or more machine learning models, a portion of a report on the application.

14. The system of claim 1, wherein the one or more processors further:
determine, based on the one or more streams of data input into the one or more machine learning models, a type of the modification; and
execute, responsive to the validation, the action to generate a report indicating the type of the modification.

15. A computer-implemented method, comprising:
receiving, by one or more processors coupled with memory, using an application programming interface call, one or more streams of data from one or more digital channels;
detecting, by the one or more processors, based on the one or more streams of data input into one or more machine learning models, an indication of a modification to a process executed by an application;
triggering, by the one or more processors, responsive to the detection of the indication, a validation operation for the modification to the process;
comparing, by the one or more processors, a version of the application corresponding to the modification with a previous version of the application stored prior to the indication of the modification;
validating, by the one or more processors, based on the comparison, the indication of the modification to the process, the indication of the modification detected from the one or more streams of data; and
executing, by the one or more processors, responsive to the validation, an action.

16. The method of claim 15, comprising:
identifying, by the one or more processors, using the one or more machine learning models and one or more sources of information on the application, information indicative of a task implemented on the application including one or more of: a work item, a communication thread, a document update, or a code change associated with a project;
identifying, by the one or more processors, based on the information, one or more one or more electronic accounts associated with the application based on metadata of the one or more electronic accounts indicative of at least one of a role, a project association, or an access permission; and
selecting, by the one or more processors, based on the one or more electronic accounts, the one or more streams of data from the one or more data channels to detect the indication of the modification.

17. The method of claim 15, comprising:
identifying, by the one or more processors, one or more rules corresponding to the one or more digital channels, the one or more rules defining at least one of a format mapping, a field mapping, or a semantic correspondence between data received from different digital channels;
converting, by the one or more processors, based on the one or more rules, one or more formats of the one or more streams of data into a uniform format that normalizes data associated with the application across the one or more digital channels, wherein the uniform format is used to generate the version of the application and the previous version of the application.

18. The method of claim 15, comprising:
receiving, by the one or more processors, a request to perform the action corresponding to a report on the application;
identifying, by the one or more processors, one or more identifiers for the one or more digital channels;
sending, by the one or more processors, the application programming interface call using the one or more identifiers for the one or more digital channels; and
executing, responsive to the validation, the action to generate an output indicative of the modification, the output comprising at least one of:
(i) a notification of the modification for display;
(ii) a report element for insertion into a report corresponding to the application; or
(iii) a message for automated processing by a computing process corresponding to one or more applications associated with the one or more digital channels.

19. The method of claim 15, comprising:
identifying, by the one or more processors, one or more electronic accounts associated with a digital channel of the one or more digital channels for exchanging information on development of the application; and
detecting, by the one or more processors, the indication of the modification to the process based on an information exchanged via the digital channel, wherein the information includes a mode of information of one or more of modes of information, the mode of information including at least one of: a string of characters, an image, an audio file or a video file and the one or more machine learning models trained on the one or more modes of information to detect a plurality of modifications comprising the modification.

20. A non-transitory computer readable storage medium storing processor-executable instructions that, when executed by one or more processors, cause the one or more processors to:
receive, using an application programming interface call, one or more streams of data from one or more digital channels;
detect, based on the one or more streams of data input into one or more machine learning models, an indication of a modification to a process executed by an application;
trigger, responsive to the detection of the indication, a validation operation for the modification to the process;
compare a version of the application corresponding to the modification with a previous version of the application stored prior to the indication of the modification;
validate, based on the comparison, the indication of the modification to the process, the indication of the modification detected from the one or more streams of data; and
execute, responsive to the validation, an action.
